(19) United States
(12) Patent Application Publication
(10) Pub. No.: US 2007/0243288 A1
(43) Pub. Date: Oct. 18, 2007

(54) Meat Having Increased Level of HDL

(76) Inventors: Daniel L. Schaefer, Wichita, KS (US); David R. McKenna, Benton, KS (US)

Correspondence Address: Christopher M. Turoski, Esq.;CARGILL, Incorporated, 14507 McGinty Road West, Wayzata, MN, 55391-5624, US

(21) Appl. No.: 11/737,596

(22) Filed: Apr. 19, 2007

Related U.S. Application Data
(63) Continuation of application No. PCT/US05/37710, filed on Oct. 19, 2005.
(60) Provisional application No. 60/620,120, filed on Oct. 19, 2004.

(51) Int. Cl. A23K 1/18; A23L 1/03; A23L 1/212; A23L 1/31; A23L 1/48; B01D 43/00

(52) U.S. Cl. 426/2; 210/767; 426/281; 426/302; 426/541; 426/615; 426/641; 426/645

(57) ABSTRACT

Meat and methods to produce meat having elevated levels of HDL or an HDL mimetic are disclosed.

### CROSS-REFERENCE TO RELATED APPLICATION(S)

This application is a continuation of PCT Patent Application No. PCT/US2005/037710, filed Oct. 19, 2005, which claims priority to U.S. Provisional Patent Application Ser. No. 60/620,120, filed on Oct. 19, 2004, the contents of which are incorporated herein in their entirety

### FIELD OF THE INVENTION

The present disclosure provides compositions of, and methods to produce meat that has enriched levels of HDL and/or HDL mimetics, lower total cholesterol and/or modified HDL/LDL ratios as compared to untreated meat products. The result is a meat product that contains elevated levels of HDL and/or HDL mimetic compounds.

### BACKGROUND OF THE INVENTION

High cholesterol is generally considered a contributing factor to coronary heart disease (CHD) and the development of atherosclerotic arterial plaques (AT). The medical field has adopted the theory that meat, specifically red meat, is a dietary contributor to CHD and AT. Because of this, many consumers follow restrictive diets that reduce the amount and type of proteins they consume.

Generally, cholesterol is qualitatively measured as either High Density Lipoprotein (HDL) or Low Density Lipoprotein (LDL). HDL and LDL can be characterized by some of the specific apolipoproteins that associate with them. HDL and LDL have a dynamic relationship to each other in that as the cellular contents exchange triacylglycerides and cholesterol esters with other cells—protein may associate or dissociate to shift HDL to LDL and vice versa. An important aspect of this relationship is that the identifying proteins are merely a part of a complex of components and therefore it is difficult to use recombinant technologies to produce actual HDL or LDL. There is growing interest in the relationship between HDL cholesterol and risk for coronary heart disease and atherosclerosis, with current theory indicating that higher HDL levels reduce the risk of CHD and AT.

Recent research has suggested that increasing the amount of HDL cholesterol or HDL-mimetic compounds in the bloodstream can reduce the risk of developing and the severity of existing atherosclerotic plaques. It is also believed that increased HDL levels help to alleviate and lower LDL levels.

Therefore, a need exists for meat products that have improved cholesterol profiles.

### BRIEF SUMMARY OF THE INVENTION

Compositions of, and methods to produce meat that has enriched levels of HDL and/or HDL mimetics, lower total cholesterol and/or modified HDL/LDL ratios as compared to untreated meat products are provided. Thus, meat products containing elevated levels of HDL and/or HDL mimetic compounds are provided.

It should be understood that HDL or an HDL mimetic and combination thereof can be used interchangeably throughout the systems and methods of the disclosure, as well as in the treated meat product(s). Therefore, it should be understood that where HDL, HDL mimetic, or combinations of HDL and HDL mimetics include combinations of one or more materials.

Suitable HDL mimetics include statins, bile acid binding resins, cholesterol absorption inhibitors, fibrates, supernutritional levels of nicotinic acid, supernutritional levels of an antioxidant, apolipoproteins, phytochemicals, phytosterols, polyunsaturated fatty acids, and/or monounsaturated fatty acids, etc.

In one aspect, the present disclosure provides HDL enriched meat. The meat is treated with HDL or an HDL mimetic, such that the meat has an increased level of HDL relative to untreated meat. The HDL enriched meat can be cooked.

Processes for producing HDL enriched meat are further provided. The methods include treating meat with HDL or an HDL mimetic, such that the treated meat has an increased level of HDL relative to untreated meat. The meat may be treated in any suitable manner for increasing the level of HDL therein. For example, the meat can be treated by contacting or spraying the HDL mimetic onto the surface of the meat, by injecting or pumping the HDL mimetic into the meat, e.g., intramuscular, or other treatment. Typically, the treated meat may have between about 1 g to about 100 g added HDL or HDL mimetic per pound of meat, and in particular, between about 10 g to about 30 g added HDL or HDL mimetic per pound of meat.

In another aspect, the present disclosure provides methods for isolating HDL or an HDL mimetic from blood from an animal (e.g., a mammal), such as a bovine. The methods include coagulating blood and separating (e.g., centrifuging) the coagulated blood to afford a supernatant that is separated from the debris. The supernatant is then treated with a precipitating agent to precipitate impurities to form a mixture that is then separated, e.g., centrifuged. The supernatant from the mixture is then isolated and affords an HDL enriched supernatant, which can be further processed, such as by drying, e.g., spray drying.

The process may be applied to an animal that is not previously treated with HDL, an animal treated with HDL or an animal treated with an HDL mimetic. In this manner, an animal can be fed a diet (described more fully below) enriched with HDL or an HDL mimetic or can be treated with HDL or an HDL mimetic prior to collection of blood, thereby producing an supernatant that is enriched with HDL or an HDL mimetic.

The enriched supernatant can be added to a food source or meat can be treated with the HDL enriched supernatant as described above. The enriched HDL supernatant isolate can be used in various products such as nutraceuticals.

The present disclosure provides efficient and simple methods for enriching meat of an animal, such as a bovine, with increased levels of HDL. The method is a diet that includes a food source that contains HDL or an HDL mimetic. After consumption of the enriched HDL diet, the meat of an animal has at least about 10 percent more HDL as compared to an animal that has not been fed the enriched diet. The resultant meat that is produced in this manner has an increased amount of HDL or HDL mimetic relative to an animal not fed the enriched diet. Additionally, the total cholesterol of the meat is lowered and/or has modified HDL/LDL ratios as compared to untreated meat products.

Although many of the embodiments address using the method, system and compositions with beef (such as steers and heifers), the method and system is applicable to all bovine, porcine, equine, caprine, and ovine animals, or any other animal slaughtered for food production including poultry and fish. In this specification, bovine animals include, but are not limited to, buffalo and all cattle, including steers, heifers, cows and bulls. Porcine animals include, but are not limited to, feeder pigs and breeder pigs, including sows, gilts, barrows and boars. Ovine animals include, but are not limited to, sheep, including ewes, rams, wethers and lambs.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION

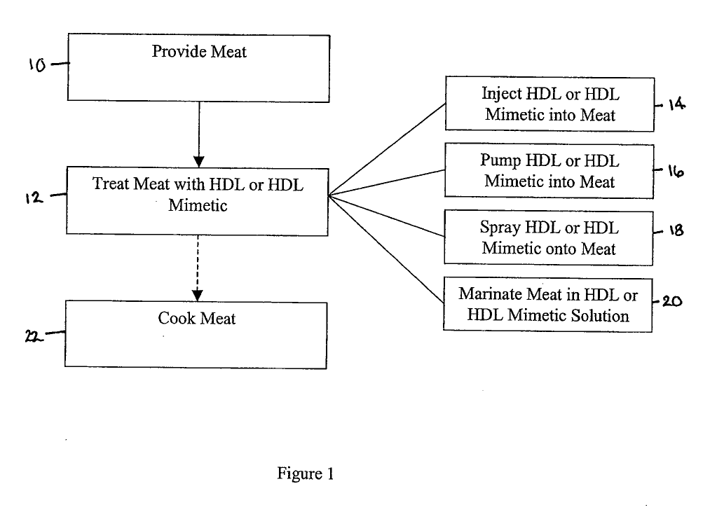

FIG. 1 diagrammatically illustrates a method of enriching meat in accordance with one embodiment.

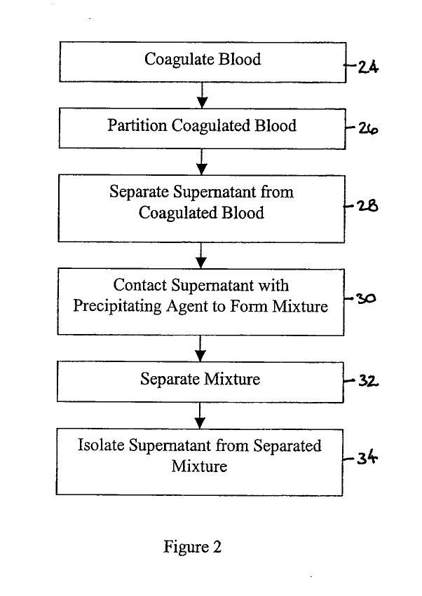

FIG. 2 diagrammatically illustrates a method of isolating HDL, an HDL mimetic, or a combination thereof in accordance with one embodiment.

### DETAILED DESCRIPTION

Compositions of, and methods to produce meat that has enriched levels of HDL and/or HDL mimetics, lower total cholesterol and/or modified HDL/LDL ratios as compared to untreated meat products are provided.

The term “statin” is understood in the art and is intended to include those compounds that lowers blood cholesterol levels by inhibiting HMG-CoA reductase. Suitable examples of statins include atorvastatin, cerivastatin, fluvastatin, lovastatin, pravastatin, rosuvastatin and simvastatin, as described in U.S. Pat. Nos. 4,231,938, 4,444,784, 4,346,277, 4,739,073, 5,006,530, 5,177,080 and WO 00/53566, the contents of which are included herein in their entirety.

The term “bile acid binding resin” is understood in the art and is intended to include those compounds that bind bile salts and prevent their reabsorption so that the body uses its cholesterol to keep making more bile salts (eventually, in theory) utilizing all available cholesterol. Suitable examples of bile acid binding resins include cholestyramine, colesevelam, and colestipol.

The term “cholesterol absorption inhibitor” is understood in the art and is intended to include those compounds that prevent the absorption of cholesterol and the reabsorption of biliary cholesterol, and lower LDL cholesterol. Their primary LDL-lowering mechanism is the inhibition of LDL formation. Suitable examples include ezetimibe.

The term “fibrate” is understood in the art and is intended to include those compounds that increase HDL and decrease triglyceride levels. Suitable examples of fibrates include fenofibrate and gemfibrozil.

The phrase “supernutritional level of nicotinic acid” is intended to mean that the accepted nutritional level of nicotinic acid (on a daily basis) is exceeded by at least 10 percent, more particularly by at least 50% and most particularly by at least 100%. Nicotinic acid decreases the production of LDL. Suitable examples include Niacin or vitamin B3.

The phrase “supernutritional level of an antioxidant” is intended to mean that the accepted nutritional level of an antioxidant (on a daily basis) is exceeded by 10 percent, more particularly by at least 50% and most particularly by at least 100%. Suitable antioxidants include, for example, ascorbic acid, α-tocopherol, glutathione, rosemary extracts and BHA or BHT.

The term “apolipoprotein” is understood in the art and is intended to mean nonfat parts of lipoproteins (proteins that carry cholesterol and triglycerides in the blood). Apolipoproteins are groups by their function into B100, A1, A2, B (B-48), C and E, with subgroups that refer to the genes that control those functions.

The phrase “monounsaturated fatty acids” (MUFAs) is understood in the art and includes those fatty acids, and their esters and salts, that include a degree of unsaturation. Suitable examples include palmitoleic (hexadecenoic) acid (C16:1n-7) and its positional isomers C16:1n-6, C16:1n-5, C16:1n-4, and C16:1n-3, myristoleic (tetradecanoic) acid (C14:1n-5) and its positional isomers C14:1n-4 and C14:1n-3, and lauroleic (dodecanoic) acid (C12:1n-3), or their mixtures, whether as the free acids, salts, or esters thereof, as described in U.S. Pat. No. 5,198,250, issued Mar. 30, 1993 to Brillhart et al., the contents of which are incorporated herein in their entirety. Additionally, MUFAs include those fatty acids having chain lengths of 18:1 and 20:1, and their positional isomers.

Alternatively, “polyunsaturated fatty acids” (PUFAs) includes those fatty acids, and their esters and salts, that include more than one degree of unsaturation, e.g., n-3 fatty acids

The term “phytochemicals” falls within the family generally recognized as monoterpenes, terpenes and/or flavonoids. Examples of monoterpenes include limonene and d-limonene, typically found in orange peel oil. Additionally, the term is understood to include those compounds described in US Publication 2002/0006953, published Jan. 17, 2002 by McGill et. al, the teachings of which are incorporated herein in their entirety.

The limonoid or limonoid glucoside group of the terpene family includes phytochemicals such as limonin or limonin glucoside from citrus seeds, as well as nomilin. Others within this group of the terpene family are liminol, deoxyliminic acid, limonin carboxymethoxime, limonin-17-O-beta-d-glucoside, obacunone, obacunone-17-O-beta-d-glucoside, nomilin-17-O-beta-d-glucoside, deacetylnomilin, deacetylnomilin-17-O-bet-a-d-glucoside and deacetylnomilic-17-O-beta-d-glucoside.

Included within the flavanones or flavanone glycosides group of the flavenoid family are the aglycones naringinin and hesperetin, as well as the glucosides naringin and hesperidin, or narirutin. Each of these flavanones is polyphenolic, and each is typically found in citrus peel and juices. Additional flavanones are eriocitrin (typically found in lemon and lime), didymin and poncitrin.

The methoxyflavone group of the flavonoid family also encompasses polyphenolic compounds. These methoxylated flavones include tangeretin and nobiletin. Other methoxyflavones include sinensetin, heptamethoxyflavone, tetra-O-methylscutellarein, and hexa-O-methylgossypetin.

The term phytosterol is understood in the art and is intended to include beta-sitosterol, beta-sitostanol, campesterol, campestanol, stigmasterol, stigmastanol, brassicasterol, brassicastanol, clionasterol, clionastano, desmosterol, chalinosterol, poriferasterol, taraxasterol, and all natural or synthesized forms and derivatives thereof, including isomers. Additionally, the term phytosterol is understood to include those compounds described in US Publication 2003/0096035, published May 22, 2003 by Perlman et al., the contents of which are incorporated herein in their entirety. It is to be understood that modifications to the phytosterols to include side chains are also included. It is also to be understood that the phytosterol can be esterified and./or hydrogenated.

Phytosterols can be obtained from vegetable oils, vegetable oil sludge, vegetable oil distillates, and other plant oil sources such as tall oils by relatively simple and inexpensive means. For example, a preparation of sterols from vegetable oil sludge by using solvents such as methanol is taught in U.S. Pat. No. 4,420,427, the contents of which are incorporated herein in their entirety. Additionally, sitosterol can be obtained from cold pressed wheat germ oil, soy extract, or rice extract. Stigmasterol is also found in trace amounts in cold pressed wheat germ oil, soy extract, saw palmetto and rice extract, and taraxasterol can be obtained from licorice root extract and dandelions.

The term “mimetic” as used in this disclosure means and includes those compounds that replicate the essential features of another molecule, i.e., HDL.

HDL and/or HDL-Mimetic Enriched Meat Products

HDL or an HDL mimetic enriched meat from a slaughtered animal is provided. The meat is treated with HDL and/or an HDL mimetic, such that the meat has an increased level of HDL relative to untreated meat. Further, the HDL enriched meat can be cooked.

Any suitable method may be used to treat the non-enriched meat with HDL or an HDL mimetic. Further, the meat may be treated at any point during meat processing. Thus, for example, the carcass as a whole may be treated before meat processing, a meat portion, such as a primal, may be treated during processing, or a cut of meat may be treated after meat processing. Suitable methods of treatment include, for example, spraying, injecting, pumping, and soaking. Thus, for example, the meat can be sprayed with a solution that contains HDL. Alternatively, the meat can be injected or pumped with a solution that contains HDL or an HDL mimetic(s). The injection can be anywhere throughout the piece of meat. In another aspect, the meat can be marinated in a solution that contains HDL or an HDL mimetic. The treated meat may be a carcass before processing according to an exemplary embodiment, and can be a further processed cut of meat such as a rib eye, chuck, ground, etc. according to alternative embodiments.

FIG. 1 illustrates one embodiment of a method of enriching meat. Meat is provided—for example at any point before, during, or after meat processing—as shown at block 10. The meat is treated with an HDL or HDL mimetic, as shown at block 12. Treatment may comprise injecting an HDL or HDL mimetic into the meat, shown at block 14, pumping an HDL or HDL mimetic into the meat, shown at block 16, spraying an HDL or HDL mimetic onto the meat, shown at block 18, marinating the meat in an HDL or HDL mimetic solution, shown at block 20, or other treatment. After such treatment, the meat may optionally be cooked, shown at block 22.

In an alternative embodiment, HDL and/or the HDL mimetic can be injected into the animal while still alive. The injection can be intramuscular, subcutaneous, percutaneous, etc. Generally, the injections are provided approximately 1 days prior to slaughter. In particular embodiments, the injection of the solution is performed 5 days prior to slaughter, 3 days prior to slaughter, or 1 day prior to slaughter.

The HDL and/or HDL mimetic enriched meat of the present disclosure contains between about 10 and about 50 percent more HDL (or HDL mimetic) relative to untreated meat according to a preferred embodiment.

Isolating HDL and/or HDL-Mimetics from Meat Processing

To meet the potential demand for HDL and/or HDL mimetic enriched meat, a process can be developed whereby HDL and HDL-mimetic compounds can be separated from blood plasma. This is the first application of capturing and purifying large quantities of HDL or an HDL mimetic with the goal of merchandising either of them as a food ingredient and/or nutraceutical supplement.

The method generally includes coagulating blood and separating, e.g., centrifuging, the coagulated blood to afford a supernatant that is separated from debris. The supernatant is then treated with a precipitating agent to form a mixture which is centrifuged. The supernatant from the mixture is isolated and comprises an HDL enriched supernatant, which may be further processed, such as by drying.

The process works for an animal that is not previously treated with HDL, an animal treated with HDL or an animal treated with an HDL mimetic. In this manner, an animal can be fed a diet (described more fully below) enriched with HDL or an HDL mimetic or can be treated with HDL or an HDL mimetic prior to collection of blood, thereby producing an supernatant that is enriched with HDL or an HDL mimetic.

The enriched supernatant may be added to a food source or meat can be treated with the HDL enriched supernatant as described above. The enriched HDL supernatant isolate may be used in various products such as nutraceuticals. Thus, HDL and/or HDL mimetic enriched foods and nutraceuticals are herewith provided.

The coagulum can be generally centrifuged from between about 2,000 rpm to about 4,000 rpm×g (e.g., 3000×g) for between about 5 minutes to about 15 minutes (e.g., 10 minutes).

The supernatant may be collected and a precipitating reagent may be added, followed by a subsequent centrifugation at 1000×g for 10 min.

Suitable precipitation agents include sodium bromide (1:2) and commercially available agents from Pointe Scientific (1:1), ProDiagnostica (2:1) and CimaScientific (1:1) (ratios are parts of precipitating agent to parts sera).

The supernatant may be isolated and dried to produce HDL and HDL-mimetic compounds. The isolates can then be used as described throughout the disclosure to increase the content of HDL or HDL mimetic in treated meat.

FIG. 2 illustrates a method of isolating HDL, an HDL mimetic, or a combination thereof from blood. The blood is coagulated, as shown at block 24, and the coagulated blood is partitioned, as shown at block 26. Supernatant is separated from the coagulated blood, shown at block 28. The supernatant is contacted with a precipitating agent to form a mixture, shown at block 30. The mixture is separated, shown at block 32, and the isolated supernatant is separated from the mixture, shown at block 34. The isolated and separated supernatant comprises an HDL, HDL mimetic, or combination thereof enriched supernatant. The enriched supernatant may be added to a food source such as meat.

HDL or HDL-Mimetic Enriched Animals

Novel feeding regimes for animals are provided that enable such animals to yield cuts of meat that are a.) lower in total cholesterol, b.) have a modified HDL-C:LDL-C ratio, and/or c.) have higher levels of HDL relative to animals that are not fed such a feeding regime.

According to an exemplary embodiment, the method includes a diet that includes a food source and/or liquid, e.g., water that contains HDL or an HDL mimetic. After consumption of the enriched HDL diet, the animal has a range of at least about 10 to about 30 percent more HDL as compared to an animal that has not consumed such an enriched HDL diet. The resultant meat that is produced in this manner has an increased amount of HDL or HDL mimetic relative to an animal not fed such a diet. Additionally, the total cholesterol of the meat is lowered and/or has modified HDL/LDL ratios as compared to meat products not subjected to the processes of the present disclosure. The present disclosure provides methods to prepare meat that has a range of at least about 10 mg/dl to about 60 mg/dl change in blood plasma cholesterol.

Suitable food sources includes grains, grass, hay, straw, cellulosic products, forages, etc. that are used in the animal nutrition industry. The HDL and/or HDL mimetics can also be included in nutritional supplements, such as vitamins, drugs, such as antibiotics, salt, water, milk, etc. One exemplary feed ingredient includes 65% soy protein, 34.9% fiber and 0.1% HDL, HDL mimetic or a combination of HDL and HDL mimetic (based on total weight).

Feeding regimes of HDL and/or HDL mimetics to an animal, described herein, can be used independently or in combination. The HDL mimetics include statins, bile acid binding resins, cholesterol absorption inhibitors fibrates, supernutritional levels of nicotinic acid, supernutritional levels of antioxidants, apolipoproteins, phytochemicals, phytosterols and/or monounsaturated fatty acids. In general, the HDL and/or HDL mimetic is included as part of the daily feed allotment for the animal's dietary intake.

Table 1 provides exemplary amounts of HDL mimetics that can be administered to animals within the scope of the present disclosure. Administration can be by diet, implantation, injection (intravenous or subcutaneous) and/or water dosimetry.

TABLE 1
Treatment doses^{a} for different compounds in different species groups

Species

| | | | | | Sheep\ | | Chicken\ | |
|---|---|---|---|---|---|---|---|---|
| Drug class | Cattle | | Swine | | Goats | | Turkey | |
| Statin-class | | | | | | | | |
| Atorvastatin | 50-580 | mg | 10-80 | mg | 5-50 | mg | 1-10 | mg |
| Fluvastatin | 100-290 | mg | 20-40 | mg | 10-30 | mg | 1-6 | mg |
| Lovastatin | 100-580 | mg | 20-80 | mg | 10-50 | mg | 1-10 | mg |
| Pravastatin | 50-290 | mg | 10-40 | mg | 5-30 | mg | 1-6 | mg |
| Rosuvastatin | 20-290 | mg | 5-40 | mg | 3-30 | mg | 1-6 | mg |
| Simvastatin | 20-580 | mg | 5-80 | mg | 3-50 | mg | 1-10 | mg |
| Bile acid | | | | | | | | |
| binding | | | | | | | | |
| Cholestyramine | 38-172 | g | 8-24 | g | 5-15 | g | 0.5-4 | g |
| Colestipol | 72-218 | g | 15-30 | g | 7-20 | g | 1-5 | g |
| Colesevelam | 14-36 | g | 3-5 | g | 1-3 | g | 0.2-1 | g |
| Fibrates | | | | | | | | |
| Fenofibrate | 240-1200 | mg | 50-160 | mg | 20-90 | mg | 5-20 | mg |
| Gemfibrozil | 7.5 | g | 1200 | mg | 500 | mg | 120 | mg |
| Others | | | | | | | | |
| Ezetimibe | 60 | mg | 10 | mg | 4 | mg | 1 | mg |
| Nicotinic acid | 2.5-15 | g | 0.8-2 | g | 200-1200 | mg | 50-400 | mg |
| Apolipoproteins | 1.2-5.4 | g | 250-750 | mg | 150-500 | mg | 20-100 | mg |

^{a}All dosages represent dose/day of treatment

The values in Table 1 reflect total dosages of various HDL mimetics for adolescent to mature animals within each species group. Because of the wide variation in weights for those animals, daily doses may be established.

Generally the HDL and/or HDL mimetic is included in the food source for about 1 day to about 100 days prior to slaughter. In certain embodiments, the HDL and/or HDL mimetic is included in the food source for between about 5 days to about 60 days, more particularly from between about 7 days to about 30 days and in particular from between about 10 days to about 15 days.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

I claim:

1. Enriched meat, comprising meat treated with HDL, an HDL mimetic or combination thereof, such that the meat has an increased level of HDL, HDL mimetic or combination thereof, relative to untreated meat.

2. The meat of claim 1, wherein the meat is uncooked.

3. The meat of claim 1, wherein the meat is cooked.

4. The meat of claim 1, wherein the meat has at least about 10 percent more HDL or HDL mimetic as compared to untreated meat.

5. The meat of claim 1, wherein the meat has at least about 20 percent more HDL or HDL mimetic as compared to untreated meat.

6. The meat of claim 1, wherein the meat is bovine.

7. The meat of claim 1, wherein the HDL mimetic is a statin, a bile acid binding resin, a cholesterol absorption inhibitor, a fibrate, a supernutritional level of nicotinic acid, a supernutritional level of an antioxidant, an apolipoprotein, a phytochemical, a phytosterol, a monounsaturated fatty acid or combination thereof.

8. The meat of claim 7, wherein the statin is atorvastatin, fluvastatin, lovastatin, pravastatin, rosuvastatin, simvastatin or combination thereof.

9. The meat of claim 1, wherein the phytochemical is a monoterpene, a terpene, a flavonoid or combination thereof.

10. The meat of claim 9, wherein the phytosterol is beta-sitosterol, beta-sitostanol, campesterol, campestanol, stigmasterol, stigmastanol, brassicasterol, brassicastanol, clionasterol, clionastanol or combination thereof.

11. A process for producing enriched meat, comprising the steps of:
treating meat with HDL, an HDL mimetic or combination thereof, such that the treated meat has an increased level of HDL, HDL mimetic or combination thereof, relative to untreated meat.

12. The method of claim 11, wherein the meat is treated by spraying the HDL or HDL mimetic onto the surface of the meat.

13. The method of claim 11, wherein the meat is treated by injecting the HDL or HDL mimetic into the meat.

14. The method of claim 13, wherein the injection is intramuscular.

15. The method of claim 11, wherein the HDL or HDL-mimetic is pumped into the meat.

16. The method of claim 11, wherein the meat is treated by marinating the meat in a solution containing the HDL or HDL-mimetic.

17. The method of claim 11, wherein the meat is bovine.

18. The method of claim 11, wherein the HDL mimetic is a statin, a bile acid binding resin, a cholesterol absorption inhibitor, a fibrate, a supernutritional level of nicotinic acid, a supernutritional level of an antioxidant, an apolipoprotein, a phytochemical, a phytosterol, a monounsaturated fatty acid or combination thereof.

19. The method of claim 18, wherein the statin is atorvastatin, fluvastatin, lovastatin, pravastatin, rosuvastatin, simvastatin, or combination thereof.

20. The method of claim 18, wherein the phytochemical is a monoterpene, a terpene a flavonoid, or combination thereof.

21. The method of claim 18, wherein the phytosterol is beta-sitosterol, beta-sitostanol, campesterol, campestanol, stigmasterol, stigmastanol, brassicasterol, brassicastanol, clionasterol, clionastano, desmosterol, chalinosterol, poriferasterol, taraxasterol or combination thereof.

22. The method of claim 11, wherein the meat has at least about 10 percent more HDL, HDL mimetic or combination thereof, as compared to untreated meat.

23. A method of isolating HDL, an HDL mimetic or combination thereof, from blood, comprising the steps of
a) coagulating blood;
b) partitioning said coagulated blood;
c) separating supernatant from said coagulated blood;
d) contacting said supernatant with a precipitating agent to form a mixture;
e) separating said mixture; and
f) isolating supernatant from said separated mixture to afford an HDL, HDL mimetic or combination thereof enriched supernatant.

24. The method of claim 23, comprising the further step of drying said enriched supernatant to afford dried HDL, HDL mimetic or combination thereof.

25. The method according to claim 23, wherein said enriched supernatant is added to a food source.

26. The method according to claim 23, wherein meat is treated with said enriched supernatant.

27. The method of claim 26, wherein the meat is treated by spraying the enriched supernatant onto the surface of the meat.

28. The method of claim 26, wherein the meat is treated by injecting the enriched supernatant into the meat.

29. The method of claim 28, wherein the injection is intramuscular.

30. The method of claim 26, wherein the meat is treated by pumping the enriched supernatant into the meat.

31. The method of claim 26, wherein the meat is treated by marinating the meat into a solution including the enriched supernatant.

32. The method of claim 26, wherein the meat is bovine.

33. The isolated enriched supernatant according to the process of claim 23.

34. A method for enriching an animal with HDL, an HDL mimetic or combinations thereof, the method comprising feeding to said animal, a diet comprising a food source comprising HDL, an HDL mimetic or combination thereof, wherein said animal has at least about 10 percent more HDL, HDL mimetic or combination thereof, as compared to an animal not fed a diet enriched with HDL, an HDL mimetic or combination thereof.

35. The method of claim 34, wherein the animal has at least about 20 percent more HDL or HDL mimetic as compared to an animal not fed a diet enriched with HDL, an HDL mimetic or combination thereof.

36. The method of claim 34, wherein the animal is steer, heifer, bullock, bull or cow.

37. The method of claim 34, wherein the HDL mimetic is a statin, a bile acid binding resin, a cholesterol absorption inhibitor, a fibrate, a supernutritional level of nicotinic acid, a supernutritional level of an antioxidant, an apolipoprotein, a phytochemical, a phytosterol, a monounsaturated fatty acid or combination thereof.

38. The method of claim 37, wherein the statin is atorvastatin, fluvastatin, lovastatin, pravastatin, rosuvastatin, simvastatin or combination thereof.

39. The method of claim 37, wherein the phytochemical is a monoterpene, a terpene, a flavonoid or combination thereof.

40. The method of claim 37, wherein the phytosterol is beta-sitosterol, beta-sitostanol, campesterol, campestanol, stigmasterol, stigmastanol, brassicasterol, brassicastanol, clionasterol, clionastano, desmosterol, chalinosterol, poriferasterol, taraxasterol or combination thereof.

41. The animal produced by claim 34.
